(19) United States
(12) Patent Application Publication
(10) Pub. No.: US 2008/0287006 A1
(43) Pub. Date: Nov. 20, 2008

(54) Electrical connector

(75) Inventor: Gianni Piovesan, Cadoneghe (IT)

Correspondence Address: MODIANO & ASSOCIATI, Via Meravigli, 16, MILANO, 20123, IT

(73) Assignee: INARCA S.P.A.

(21) Appl. No.: 12/010,332

(22) Filed: Jan. 24, 2008

(30) Foreign Application Priority Data
Feb. 2, 2007 (IT) PD2007U000020

(51) Int. Cl. H01R 13/40

(52) U.S. Cl. 439/595

(57) ABSTRACT

An electrical connector, of the type constituted by a box-like body with a closure cover which is associated therewith by way of a film hinge and inside which there is at least one first seat, with an opening for access on the part of the cover, for a female electrical connection terminal for an electrical cable and at least one optional contiguous second seat, which is open onto a corresponding first seat, for a male electrical terminal to be mated with the female terminal; at the free end of the cover there is at least one tab in which there is an engagement slot for a corresponding tooth which protrudes from the box-like body. At the edge of the box-like body arranged between the film hinge and the at least one opening for accessing the corresponding first seat there is a space for the free flexing of the film hinge.

The present invention relates to an electrical connector.

### BACKGROUND OF THE INVENTION

In order to facilitate and automate the assembly of the electrical connections of the electrical/electronic components of a generic machine or device, connectors for accommodating electrical terminals to be connected to electrical connecting wires are currently used increasingly.

In particular, connecting assemblies thus formed are used in wiring to be mass-manufactured.

These known electrical connectors are constituted generally by a box-like body, which has a closure cover which is associated therewith by means of a film hinge; inside the box-like body there are one or more seats, with access from the cover side, for a corresponding number of female electrical connection terminals for a respective electrical cable, and optional contiguous second seats, which are open onto a corresponding first seat, for male electrical terminals to be mated with the female terminals.

The free end of the cover has tabs, on each of which there is an engagement slot for a corresponding tooth which protrudes from the box-like body in order to close the cover with a snap action.

The edge of the box-like body located between the film hinge and the openings for accessing the first seats is generally in relief with respect to the rest of the edges of the openings and has a curved contact surface for the film hinge in the configuration in which the cover is closed.

If, due to production problems, for example related to the dimensional tolerances of the connector, the contact of the hinge against the curved surface of the edge is not ideal, unwanted situations can occur for the integrity of the hinge and for the functionality of the connector as a whole.

A first unwanted situation can occur if the hinge, when the cover is closed, is placed under tension because it is “shorter” than the extension of the arc of the profile of the curved surface, whereas instead a second inconvenient situation can be caused by the “greater” length of the hinge with respect to the arc; in this case, the cover might be closed with a certain play and therefore may open in case of excessive stresses, which a connector undergoes if, for example, it belongs to an electric motor of a washing machine or of a car or of another device which is subjected to vibrations, jolts, impacts or other similar stresses.

The opening of the cover, either due to breakage of the hinge or due to disengagement caused by loose closure, allows the penetration of dirt into the connector and places at risk the stability of the contact, since the cable, which is normally locked in the connector by the closed cover, is no longer stably retained in its seat.

### SUMMARY OF THE INVENTION

The aim of the present invention is to provide an electrical connector which is capable of obviating the drawbacks shown by similar known types of connector.

Within this aim, an object of the present invention is to provide a connector whose structure allows to protect in the best possible way the integrity of the film hinge and accordingly ensure optimum closure of the cover on the box-like body of the connector.

Another object of the present invention is to provide a connector which is adapted to be fitted on preset elements of a known type so as to accommodate known terminals and be installed by means of known equipment.

Another object of the present invention is to provide an electrical connector which can be manufactured cheaply with known systems and technologies.

This aim and these and other objects, which will become better apparent hereinafter, are achieved by an electrical connector, of the type constituted by a box-like body with a closure cover which is associated therewith by means of a film hinge, inside said box-like body there being at least one first seat, with an opening for access on the part of the cover, for a female electrical connection terminal for an electrical cable and at least one optional contiguous second seat, which is open onto a corresponding first seat, for a male electrical terminal to be mated with said female terminal, the free end of said cover having at least one tab in which there is an engagement slot for a corresponding tooth which protrudes from the box-like body, said connector being characterized in that at the edge of the box-like body arranged between said film hinge and the at least one opening for accessing the corresponding first seat there is a space for the free flexing of said film hinge.

### BRIEF DESCRIPTION OF THE DRAWINGS

Further characteristics and advantages of the invention will become better apparent from the following detailed description of two preferred but not exclusive embodiments thereof, illustrated by way of non-limiting example in the accompanying drawings, wherein:

FIG. 1 is a perspective view of a connector according to the invention in a first embodiment thereof;

FIG. 2 is a front view of the connector of FIG. 1;

FIG. 3 is a sectional view, taken along the line III-III of FIG. 2, related to the connector in the closed condition;

FIG. 4 is a sectional view, taken along the line IV-IV of FIG. 2, with the connector in the open condition;

FIG. 5 is a perspective view of a connector according to the invention in a second embodiment thereof.

### DESCRIPTION OF THE PREFERRED EMBODIMENTS

With reference to the figures, an electrical connector according to the invention is generally designated by the reference numeral 10.

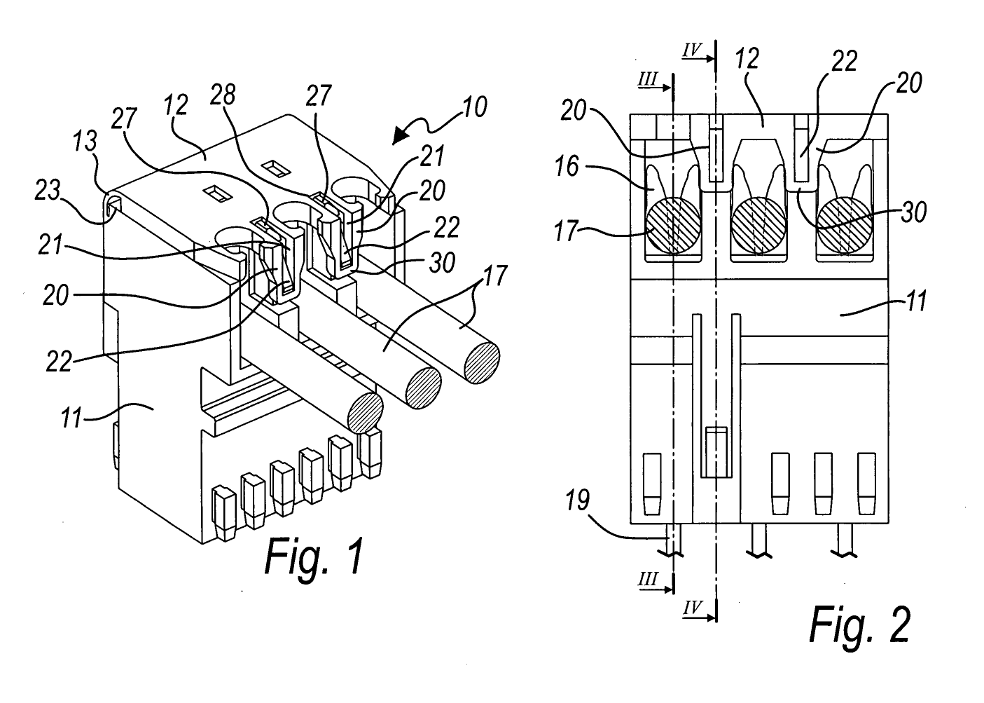

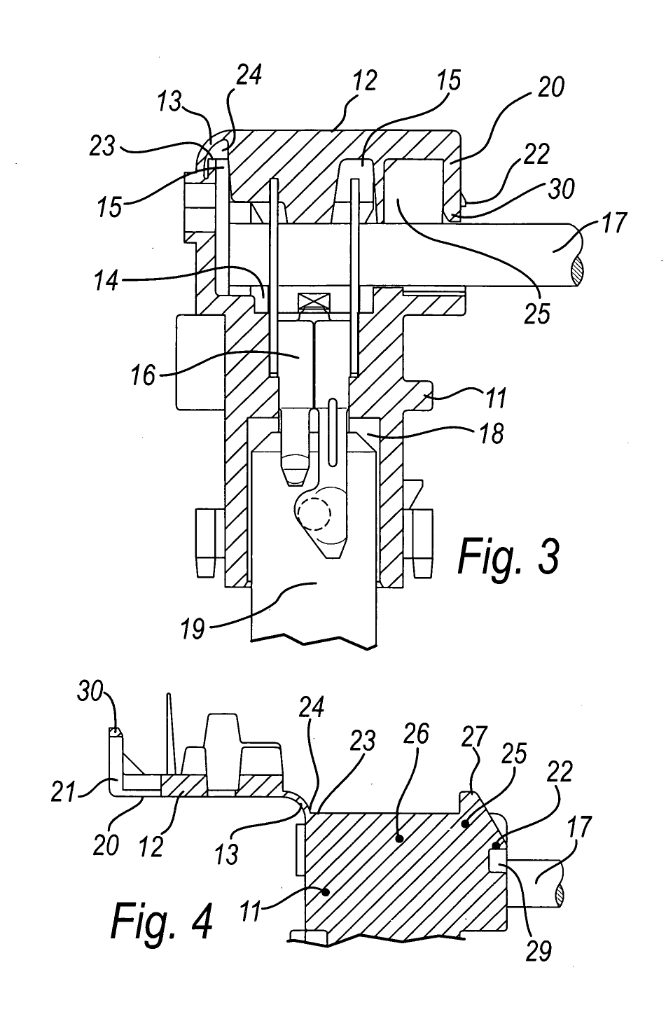

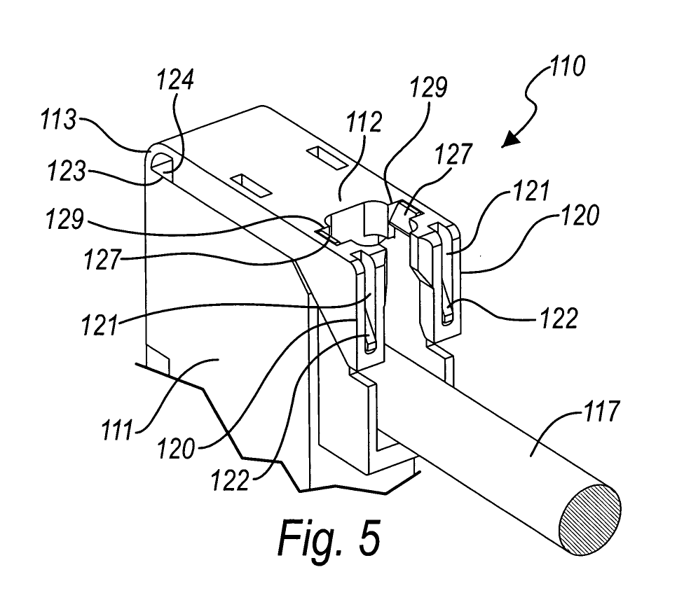

The connector 10, the first embodiment of which is shown in FIGS. 1 to 4, is of the type constituted by a box-like body 11 with a closure cover 12 which is associated therewith by means of a film hinge 13.

In this embodiment, which is described by way of non-limiting example of the invention, inside the box-like body 11 there are three first seats 14, with an opening 15 for access from the side of the cover 12, for a female electrical terminal 16 for connection of an electrical cable 17.

Each first seat 14 is matched by a contiguous second seat 18, which is open onto the first seat 14, for a male electrical terminal 19 to be mated with the female terminal 16.

The free end of the cover 12 is provided with two tabs 20, on each of which there is an engagement slot 21 for a corresponding tooth 22 which protrudes from the box-like body 11.

A space 24 for the free flexing of the film hinge 13 is formed at the edge 23 of the box-like body 11 located between the film hinge 13 and the opening 15 for accessing the first seats 14.

The edge 23 is substantially flat, and the film hinge 13, in the configuration in which the cover 12 is closed, is not in contact with it.

This solution allows the hinge 13 to have greater freedom in adapting to the shape given to it by the cover 12 in the closed configuration, without having to adapt to a shape imposed by a curved surface of an edge in relief, as in known types of connector.

In this manner, the hinge 13 cannot be under tension because it is “shorter” than the extension of the arc of the profile of the curved surface of the edge, and this cause of breakage is eliminated.

Each tooth 22, being two in the first embodiment, protrudes from a plate-like portion 25 which extends from a partition 26 between two laterally adjacent seats 14 for the terminals 16.

The plate-like portion 25 has a wider centering head 27 which, in the configuration in which the cover 12 is closed, is arranged proximate to, or in contact against, a translational motion-preventing abutment provided on the cover 12.

In this first embodiment of the invention, the abutment is provided by a substantially vertical end face 28 of the slot 21; the face 28 prevents the unwanted movement of the cover 12 in the direction and with the orientation from the hinge 13 to the tooth 22.

The end portion of the tab 20, which has a substantially U-shaped contour, engages, in the configuration in which the cover 12 is closed, below the tooth 22 in a groove 29 which is designed to prevent, in cooperation with a transverse part 30 of the U-shaped portion, the unwanted movement of the cover 12 in the direction and with the orientation from the tooth 22 to the hinge 13, i.e., preventing the translational motion of the cover 12 in the opposite direction to what is done by the face 28 of the slot 21 with the wider head 27 of the plate-like portion 25.

In a second embodiment of the invention, which also is an exemplifying embodiment, the connector according to the invention, designated by the reference numeral 110, has a box-like body 111 which is preset to accommodate a single female terminal for the cable 117.

The cover 112 has two lateral tabs 120 with the slots 121 for two teeth 122.

The space 124 between the hinge 113 and the cover 112, at the edge 123, is clearly visible.

In this embodiment, the abutment is provided by a recess 129 which is provided to the rear of the slot 121 and proximate thereto, and a corresponding wider head 127 is inserted in the recess 129.

The tab 20 and 120 engaged on the corresponding tooth 22 and 122, in cooperation with the wider head 27 and 127 and the corresponding abutment, prevent the cover from being closed with a play which allows opening in case of excessive stresses.

The connector 10 and 110 according to the invention, thanks to the space 24 and 124 for the movement of the hinge 13 and 113, reduces the risks of unwanted opening of the cover, limiting the risks of breakage of the hinge and of disengagement due to loose closure, with all the advantages of integrity and cleanness for the contacts provided in said connector.

It is noted that the embodiments described here are to be understood as exemplifying and non-limiting; the connector according to the invention can therefore be provided with a number of seats for terminals, and with a number of engagement tabs and teeth, at will, depending on requirements and needs of the manufacturer and user; further, it should be understood that the seats 14 and 18 for the terminals can be provided to accommodate any type of terminal according to requirements and to the applications for which the connector according to the invention is provided.

In practice it has been found that the invention thus described solves the problems noted in similar known types of electrical connector.

In particular, the present invention provides a connector whose structure allows to protect in the best possible way the integrity of the film hinge and consequently ensure optimum closure of the cover onto the box-like body of the connector.

Further, the invention provides a connector which is adapted to be fitted on preset elements of a known type, to accommodate known terminals, and be installed by means of known equipment.

Moreover, the present invention provides an electrical connector which can be manufactured cheaply with known systems and technologies.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Utility Model Application No. PD2007U000020 from which this application claims priority are incorporated herein by reference.

What is claimed is:

1. An electrical connector, of the type constituted by a box-like body with a closure cover which is associated therewith by means of a film hinge, inside said box-like body there being at least one first seat, with an opening for access on the part of the cover, for a female electrical connection terminal for an electrical cable and at least one optional contiguous second seat, which is open onto a corresponding said first seat, for a male electrical terminal to be mated with said female terminal, a free end of said cover having at least one tab in which there is an engagement slot for a corresponding tooth which protrudes from the box-like body, wherein at an edge of the box-like body arranged between said film hinge and the at least one opening for accessing the corresponding first seat there is a space for free flexing of said film hinge.

2. The connector of claim 1, wherein said edge is substantially flat and the film hinge, in the configuration in which the cover is closed, is not in contact with it.

3. The connector of claim 1, wherein each tooth protrudes from a plate-like portion which extends from the partition between two laterally adjacent seats for terminals.

4. The connector of claim 3, wherein said plate-like portion has a wider centering head which, in the configuration in which the cover is closed, is arranged proximate to, or in contact against, a translational motion-preventing abutment provided on said cover.

5. The connector of claim 4, wherein said abutment is provided by a substantially vertical end face of the slot, which prevents the unwanted movement of the cover in a direction and with an orientation from the hinge to the tooth.

6. The connector of claim 4, wherein said abutment is provided by a recess which is provided to the rear of the slot and proximate thereto.

7. The connector of claim 1, wherein an end portion of said tab, which is substantially U-shaped, engages, in a configuration in which the cover is closed, below said tooth in a groove which is designed to prevent, in cooperation with a transverse part of the U-shaped portion, an unwanted movement of the cover in the direction and with the orientation from the tooth to the hinge.
